(19) United States
(12) Patent Application Publication
(10) Pub. No.: US 2023/0049418 A1
(43) Pub. Date: Feb. 16, 2023

(54) INFORMATION QUALITY OF MACHINE LEARNING MODEL OUTPUTS

(71) Applicant: Capital One Services, LLC, McLean, VA (US)

(72) Inventors: Prashanta SAHA, Bangalore (IN); Souvik BISWAS, Bangalore (IN); Joydeep DASGUPTA, Bangalore (IN)

(73) Assignee: Capital One Services, LLC, McLean, VA (US)

(21) Appl. No.: 17/486,685

(22) Filed: Sep. 27, 2021

(30) Foreign Application Priority Data
Aug. 10, 2021 (IN) 202141036064

(51) Int. Cl. G06N 5/02; G06F 16/28

(52) U.S. Cl. CPC G06N 5/022; G06F 16/288

(57) ABSTRACT

Some embodiments of the present application include obtaining datasets including a plurality of features and computing a correlation score between each of the features. Based on the correlation scores, the features may be clustered together such that each cluster includes features that are correlated with one another, and features included in different feature clusters lack correlation with one another. A machine learning model may be selected based on a set of input features for the model and the plurality of clusters such that each input feature is included in one of the feature clusters and no feature cluster includes more than one of the input features. Datasets may then be selected based on the set of input features, which may be used to generate training data for training the machine learning model.

### CROSS-REFERENCE TO RELATED APPLICATIONS

This application claims the benefit of priority of Indian Patent Application No. 202141036064, filed Aug. 10, 2021, the content of which is incorporated herein in its entirety by reference.

### BACKGROUND

Training data includes a plurality of features, some of which may be correlated with one another. For example, if two features are correlated, adjustments to one can affect the influence of the other. Depending on how strongly correlated the features are, the adjustments to one feature may have minimal effect on the output of a machine learning model or may have a significant impact on the output of the machine learning model. Minimizing features that are correlated within the training data, such as by identifying features that are uncorrelated with one another, can enable training data to be generated that, when used to train a machine learning model, improves the quality of information output by the machine learning model.

### SUMMARY

Some embodiments involve improving the quality of information output by a machine learning model by minimizing correlation of features in training data used to train the machine learning model. Highly correlated features can inadvertently impact a machine learning model’s output as adjustments to one of the correlated features can affect the impact of the other correlated feature(s). By minimizing how correlated the features are in training data used to train the machine learning model, the trained machine learning model may reduce or even eliminate the effects of multicollinearity on the machine learning model’s output.

In some embodiments, datasets including a plurality of features may be obtained. Correlation scores may be computed based on the datasets, where the correlation scores indicate a correlation between features. Based on the computed correlation scores, a plurality of feature clusters can be generated, where features in each feature cluster lack correlation with features included in other feature clusters. A machine learning model may be selected based on a set of input features associated with the machine learning model and the feature clusters. The set of input features may represent features that are capable of being used as input for the machine learning model. A subset of the obtained datasets may be selected based on the set of input features associated with the machine learning model, and training data for training the machine learning model may be generated based on the selected subset of datasets.

Various other aspects, features, and advantages of the invention will be apparent through the detailed description of the invention and the drawings attached hereto. It is also to be understood that both the foregoing general description and the following detailed description are examples and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows a system for minimizing feature correlation in training data, in accordance with one or more embodiments.

FIG. 2 shows a process for developing and deploying a machine learning model, in accordance with one or more embodiments.

FIG. 3 shows a scoring subsystem for computing correlation scores for features, in accordance with one or more embodiments.

FIG. 4 shows a clustering subsystem for generating a cluster plot of features, in accordance with one or more embodiments.

FIG. 5 shows a cluster plot of features, in accordance with one or more embodiments.

FIG. 6 shows a model database storing data related to various machine learning models, in accordance with one or more embodiments.

FIG. 7 shows a model selection subsystem for selecting a machine learning model with which training data is to be generated for, in accordance with one or more embodiments.

FIG. 8 shows a training subsystem for generating training data for training a machine learning model, in accordance with one or more embodiments.

FIGS. 9A and 9B show graphs used to identify volatility in time series data, in accordance with one or more embodiments.

FIG. 9C shows an example user interface including variable metrics generated based on the graphs of FIGS. 9A and 9B, in accordance with one or more embodiments.

FIGS. 10A and 10B show a diagram for detecting outlier observations for a machine learning model, and a user interface for identifying drivers of the observed outliers, respectively, in accordance with one or more embodiments.

FIGS. 11A and 11B show feature comparison plots and a user interface for detecting distribution inconsistencies between training data, validation data, and out-of-time data, in accordance with one or more embodiments.

FIG. 12 shows a flowchart of a method for generating training data including features having minimized correlation, in accordance with one or more embodiments.

### DETAILED DESCRIPTION

In the following description, for the purposes of explanation, numerous specific examples are set forth in order to provide a thorough understanding of example embodiments. It will be appreciated, however, by those having skill in the art that embodiments may be practiced without these specific details or with an equivalent arrangement.

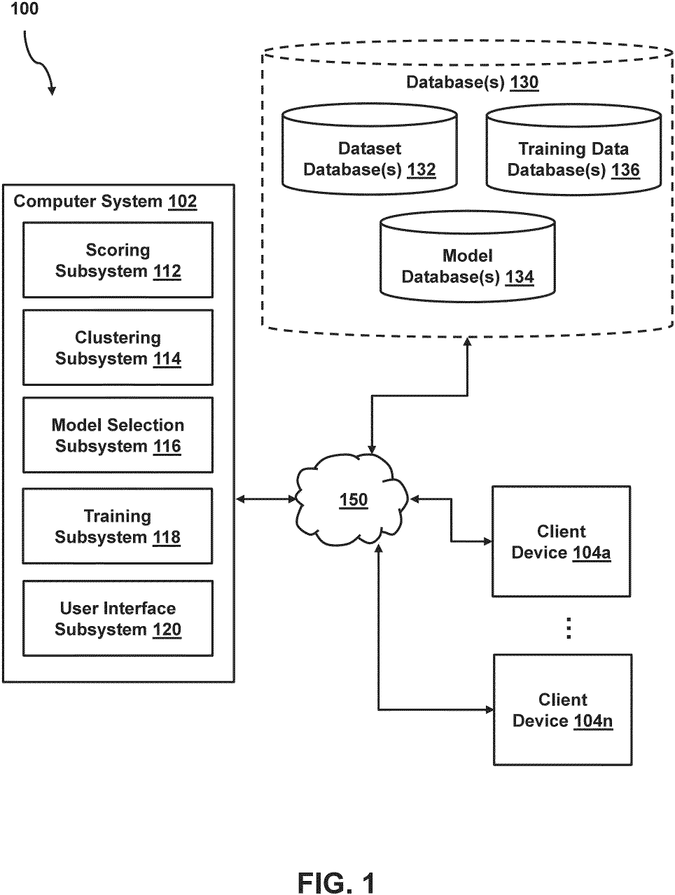

FIG. 1 shows a system for minimizing feature correlation in training data, in accordance with one or more embodiments. As shown in FIG. 1, system 100 may include computer system 102, client devices 104a-104n, which collectively may be referred to herein as “client devices 104,” and may individually be referred to herein as “client device 104,” database(s) 130, or other components. Computer system 102 may include scoring subsystem 112, clustering subsystem 114, model selection subsystem 116, training subsystem 118, user interface subsystem 120, and/or other components. Each client device 104 may include any type of mobile terminal, fixed terminal, or other device. By way of example, client device 104 may include a desktop computer, a notebook computer, a tablet computer, a smartphone, a wearable device, or other client device. Users may, for instance, utilize one or more client devices 104 to interact with one another, one or more servers, or other components of system 100. It should be noted that, while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of client device 104. It should also be noted that, although some embodiments are described herein with respect to machine learning models, other prediction models (e.g., statistical models or other analytics models) may be used in lieu of or in addition to machine learning models in other embodiments (e.g., a statistical model replacing a machine learning model, and a non-statistical model replacing a non-machine-learning model in one or more embodiments). For instance, a machine learning model represents one type of prediction model, however, not all prediction models are required to be machine learning models.

In some embodiments, a prediction model may include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

As an example, a machine learning model may take inputs and provide outputs. In some embodiments, the outputs may be fed back to the machine learning model as inputs to train the machine learning model (e.g., alone or in conjunction with user indications of the accuracy of the outputs, labels associated with the inputs, or with other reference feedback information). In some embodiments, the machine learning model may update its configurations (e.g., weights, biases, or other parameters) based on its assessment of its predictions (e.g., the outputs) and reference feedback information (e.g., user indication of accuracy, reference labels, or other information). In some embodiments, where the machine learning model is a neural network, connection weights may be adjusted to reconcile differences between the neural network’s prediction and the reference feedback. Some embodiments include one or more neurons (or nodes) of the neural network requiring that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions.

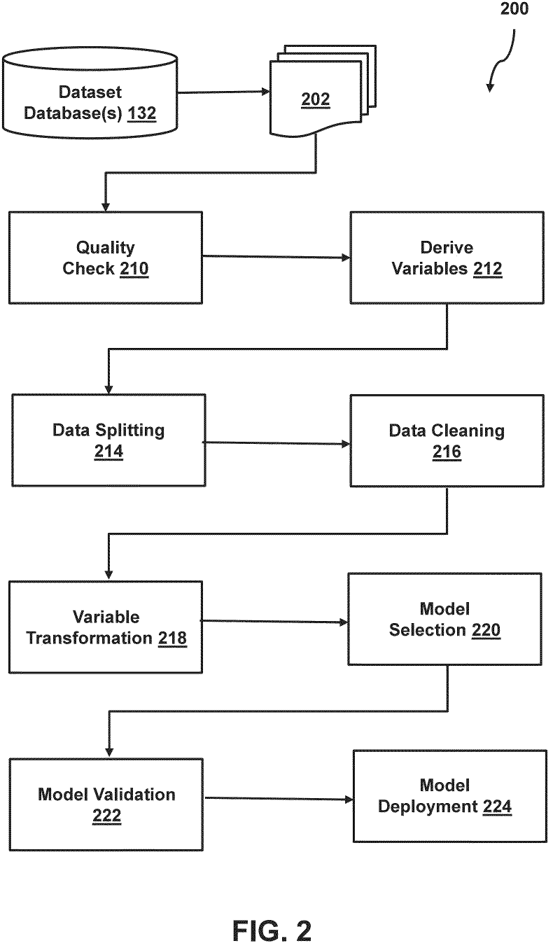

Machine learning development is a process for developing machine learning models. Datasets may be obtained and used to generate training data, and the training data may then be used to train a machine learning model. In some cases, the machine learning development process may also include a deployment process where the trained (and validated) machine learning model can be deployed to a production environment for use on real-world data (e.g., not training data). As seen, for example, with reference to FIG. 2, process 200 includes a number of steps in order to develop a machine learning model for deployment. Process 200 may begin with datasets being pulled from a database storing a plurality of datasets. For example, datasets 202 may be retrieved from dataset database 132. In some embodiments, dataset database 132 may be a repository configured to store datasets retrieved from one or more data sources, such as real-time applications, or other data sources. Each of datasets 202 may include a plurality of data items that may represent one or more features. For example, datasets 202 may include a plurality of images, each of which may represent one or more image features (e.g., color, edges, grayscale, etc.). As another example, datasets 202 may include credit card applications, each of which may include one or more financial features (e.g., a FICO score, credit limit, annual income, etc.).

Datasets 202 may be pulled from dataset database 132 responsive to a data pull request, such as an API call. After obtaining datasets 202, process 200 may include a quality check 210 that parses datasets 202 and identifies the different types of features included therein. For example, datasets 202 may include metadata indicating the different types of features. In some embodiments, quality check 210 may also identify redundant variables. A redundant variable refers to a variable that can appear multiple times within datasets 202 but refers to a same entity or feature type. For example, the feature “account identifier” may appear multiple times within datasets 202, each being associated with other, different features. For instance, the feature “account identifier” may be associated with both of the features “FICO score” and “credit limit.” Quality check 210 may identify these instances of redundant features, and in some embodiments, flag the particular feature that is redundant. Additionally, quality check 210 may be configured to identify issues associated with some or all of the features included in datasets 202. In some embodiments, variable level monitoring (VLM) may be performed for all of the features, which may also be referred to herein interchangeably as “variables,” to identify any issues that may be present. Quality check 210 may execute a package of quality check programs to identify various issues that may be present within datasets 202. As an example, quality check 210 may determine whether a null set is present within datasets 202 with respect to any of the features expected to be included within datasets 202. Additionally, quality check 210 may generate plots of each feature over time to determine changes that may have occurred to the feature over a given time range of datasets 202. In some embodiments, quality check 210 may be configured to filter out features that may have issues (e.g., abnormal distribution over time, null set, etc.).

At derive variables 212, new variables may be generated from the original variables included in datasets 202. For example, the feature utilization as Total Balance may be transformed into utilization as credit limit. The derived variables may be useful when the datasets are to be input into a machine learning model, as the original variables may not be able to be used as inputs for the given model. In some embodiments, derive variables 212 may include encoding categorical variables. For example, each variable (e.g., feature) may be encoded with a metadata tag indicating its variable type, which assists in identifying which variables can be used when inputting datasets into the machine learning model.

Data splitting 214 may take datasets 202, including the newly created variables, and may split datasets 202 into training data and test data. In some cases, out-of-time (OOT) data may also be generated from datasets 202. The training data, test data, and OOT may collectively be referred to as “build data.” The training data may be used to train the machine learning model, whereas the test data may be used to determine how well the machine learning model has been trained. In some embodiments, if the machine learning model is determined to be trained poorly (e.g., an accuracy of the model is less than a threshold accuracy), then new datasets may be retrieved from dataset database 132, and the new datasets may be used to develop new training data and new test data to retrain the model.

At data cleaning 216, the build data may be treated if missing observations are present, or if it is determined that any outliers are present in the data. In order to ensure that the model is accurately trained, the build data should accurately reflect the types of data the model is to expect in real-world applications. Therefore, identifying outliers, or other abnormalities, in the data prior to being used to train the model can eliminate potential sources of error.

At variable transformation 218, variables included in the build data may be transformed to eliminate potential dependencies from multiple other variables. For example, some variables may be related to multiple other variables. As some machine learning models are unable to handle variables that are not linearly related to other variables, variable transformation 218 can identify non-linearly related variables, and can transform those variables into variables that are linearly related to other variables.

Model selection 220 may apply a model selection process for selecting a machine learning model to use. Different machine learning models may have different use cases and benefits, and selection of a machine learning model that is unsuitable may generate errors when trained with the build data. In some embodiments, a forward or backward model selection process may be used to select the machine learning model. In some embodiments, variables that are determined to be inconsistent across datasets 202 may be identified, and variables that are impacted by multicollinearity may be dropped.

Model validation 222 may include determining whether the accuracy of the model satisfies an accuracy threshold. For example, the model may be checked using the test data previously obtained to determine whether the training of the model was successful. If the model validation fails (e.g., the accuracy of the model is less than the accuracy threshold, then the model may be retrained. Model deployment 224 may include deploying the model to a production environment or other environment where the model may be used.

The training data used to train a given machine learning model can often times have a technical problem of including features that are correlated with one another. Correlated features refer to features that are related to one another. In some embodiments, a model may be affected by multicollinearity, which refers to a feature that can be linearly predicted by other features. For example, two features that are correlated may convey the same or similar information to one another, as well as, or alternatively, cause an output of a machine learning model to convey the same or similar information. Adjustments to one of the correlated features may adjust the other correlated features.

A technical solution to the aforementioned technical problem is described herein, particularly for developing a machine learning model. Generally, the technical solutions include selecting the features that contribute the most to the quality of the machine learning model, and reducing or otherwise eliminating features having multicollinearity. By selecting the features that provide the most quality to the machine learning model, the technical solution described herein has a technical effect of improving the accuracy of variables predicted by the machine learning model. Using features that are not important to the model can cause the model’s accuracy and performance to decrease. Therefore, generating training data, or otherwise training a machine model using training data that is free of multicollinearity, or has minimal multicollinearity, improves the quality of the outputs of the machine learning model. Additionally, by generating training data that is free of multicollinearity, an ability to explain results obtained by the trained machine learning model can be improved, as it is easier to identify which feature or features contribute to the obtained results. For example, it is easier to determine which feature taken as input by the trained machine learning model caused a particular output result because the model was trained using training data that included uncorrelated features.

In some embodiments, generating training data having features that are free from or have a reduced impact from multicollinearity includes obtaining datasets. The obtained datasets include a plurality of features. For instance, the datasets may represent data items, and each data item may be expressed using a feature. For example, the datasets may include images, and each image may be represented using color values. As another example, the datasets may include credit card applications, and each application may be represented using average annual salary. As still yet another example, the datasets may include vaccine efficacies, and the vaccine efficacies may be represented via a detected protein level.

For each feature included in the datasets, a correlation score may be computed. The correlation score may indicate how well correlated each feature is to each other feature. In some embodiments, the correlation score may be represented using a Pearson score, computed using a Pearson Correlation Coefficient. In some embodiments, the correlation score may be represented using a Spearman Coefficient score computed using a Spearman Correlation Coefficient. In some embodiments, the correlation score may be represented using a Variance Inflation Factor (VIF) computed by determining how much a variance of an estimated regression coefficient is increased due to collinearity.

The features included in the datasets may be clustered together based on the correlation scores. For example, features that have a high correlation score, indicating the features are strongly correlated, are placed in a same cluster, whereas features that are not correlated with one another are located in different clusters. Therefore, each cluster can contain features correlated with one another, and which lack correlation with features included in each other cluster. In some embodiments, the features included within a given cluster may also be ranked based on the respective correlation scores. For example, two features that have a high correlation score may be ranked higher than two features that have a low correlation score.

In some embodiments, a plurality of machine learning models may be stored in a database (e.g., model database 134). Each machine learning model may take different features as inputs. The input features for some or all of the machine learning models may be determined to identify which machine learning model is to be selected for training. In some embodiments, a first machine learning model may be selected from the available machine learning models based on the set of input features associated with the first machine learning model. Some embodiments may include selecting the first machine learning model based on each input feature being included in a different one of the feature clusters, and no one feature cluster includes more than one of the input features. For example, a first machine learning model may take, as input, three input features: A, B, and C. Feature A may be included in a first feature cluster, feature B may be included in a second feature cluster, and feature C may be included in a third feature cluster. In this particular example, the first machine learning model may be selected because each of the input features A, B, and C are only included in one of the feature clusters, and each of the first, second, and third feature clusters only includes one of the input features A, B, and C. As another example, a second machine learning model may take, as input, three input features D, E, and F. Feature D may be included in a first feature cluster, feature E may be included in a second feature cluster, and feature F may also be included in the second feature cluster. In this particular example, selection is non-optimal because some of the features have multicollinearity.

In some embodiments, a subset of the datasets previously obtained, or additional datasets from dataset database 132 may be selected. The subset of datasets may be selected based on the set of input features associated with the selected machine learning model. In particular, the subset of datasets may be selected such that each dataset includes one or more features of the set of input features associated with the selected machine learning model. Referring to a previous example, datasets may be selected based on those datasets including feature A, feature B, feature C, features A and B, features A and C, or features A, B, and C. In some embodiments, training data for training the selected machine learning model may be generated based on the selected subset of datasets such that the first training data includes the selected subset of datasets.

In some embodiments, a user interface (UI) may be generated for displaying the plurality of feature clusters. The UI may render a cluster plot including a graphical depiction of the feature clusters. In some embodiments, the cluster plot may display each feature cluster having a size related to a number of features included in that feature cluster. For example, a feature cluster having more features than another feature cluster may be displayed larger, more prominently, or in any other distinguishing manner when rendered within the cluster plot.

Returning to FIG. 1, scoring subsystem 112 may be configured to obtain datasets from dataset database 132. Each of the obtained datasets may include one or more data items representing a plurality of features. For instance, the datasets may represent data items, and each data item may be expressed using a feature. For example, the datasets may include images, and each image may be represented using color values. As another example, the datasets may include credit card applications, and each application may be represented using average annual salary. As still yet another example, the datasets may include vaccine efficacies, and the vaccine efficacies may be represented via a detected protein level.

Scoring subsystem 112 may be configured to compute a correlation score for each of the features represented by the obtained datasets. The correlation score may indicate how well correlated each feature is to each other feature. In some embodiments, the correlation score may be represented using a Pearson score, computed using a Pearson Correlation Coefficient. In some embodiments, the correlation score may be represented using a Spearman Coefficient score computed using a Spearman Correlation Coefficient. In some embodiments, the correlation score may be represented using a Variance Inflation Factor (VIF) computed by determining how much a variance of an estimated regression coefficient is increased due to collinearity.

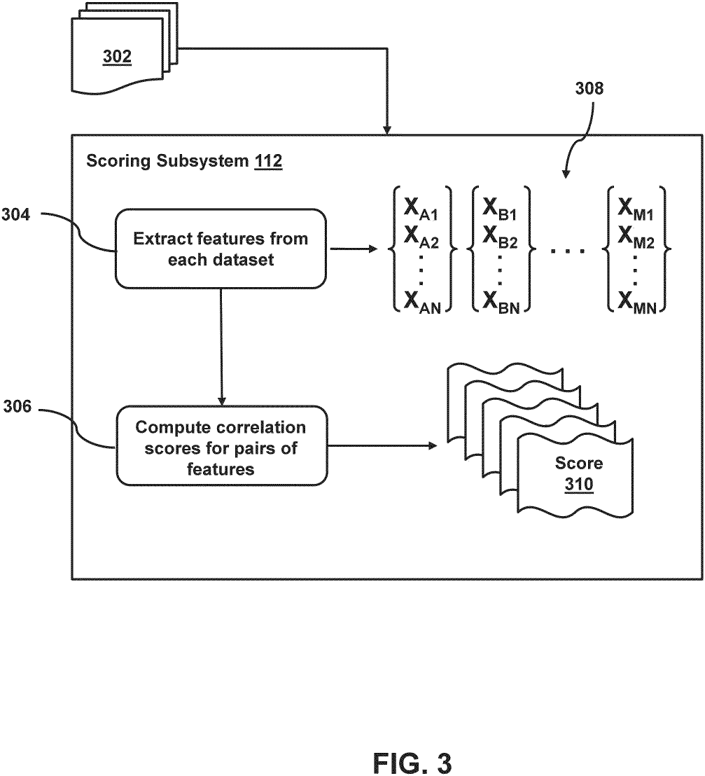

As an example, with reference to FIG. 3, scoring subsystem 112 may be configured to obtain datasets 302. In some embodiments, datasets 302 may be retrieved from dataset database 132, however some or all of datasets 302 may alternatively or additionally be retrieved from one or more other data sources (e.g., real-time applications, batch processing systems, etc.). At 304, scoring subsystem 112, upon receipt of datasets 302, may extract features from each of datasets 302. In some embodiments, scoring subsystem 112 may parse datasets 302 to identify the data items stored therein, and further identify which features are represented by each of those data items. Identifying the features may include performing a semantic analysis of the data items to identify entities described by or included within each data item, resolving a label (e.g., tag) for each entity, and attributing the label to each entity (if those entities are not labeled). After the data items are parsed, the features included within the data items may be grouped together by the data item with which they were extracted from. In some embodiments, the features may be grouped based on similarity to one another. For example, each of groups 308 represents a group of features extracted from datasets 302. For instance, a first group may include features Xai, X_{A2}, ..., X_{AN}, a second group may include features X_{B1}, X_{B2}, ..., X_{BN}, and an M-th group including features X_{M1}, X_{M2}, ..., X_{MN}. In some embodiments, each of the M groups may include a same number of features (e.g., N features), however, some groups may include fewer (or more) features.

At 306, a correlation score 310 for pairs of features may be computed. In some embodiments, the correlation score may be between features of a same group (e.g., a correlation score between feature X_{A1} and feature X_{A2}), between features of different groups (e.g., a correlation score between feature X_{A1} and feature X_{B1}), or other combinations. As mentioned previously, the correlation score may indicate how correlated two features are to one another. Two features that are strongly correlated indicates that adjustments to one of the features also causes the other feature to be adjusted. Two features that are weakly correlated indicates that adjustments to one of the features does not cause much adjustment to the other feature. Two features that are not correlated indicates that adjustments to one of the features does not affect the other feature.

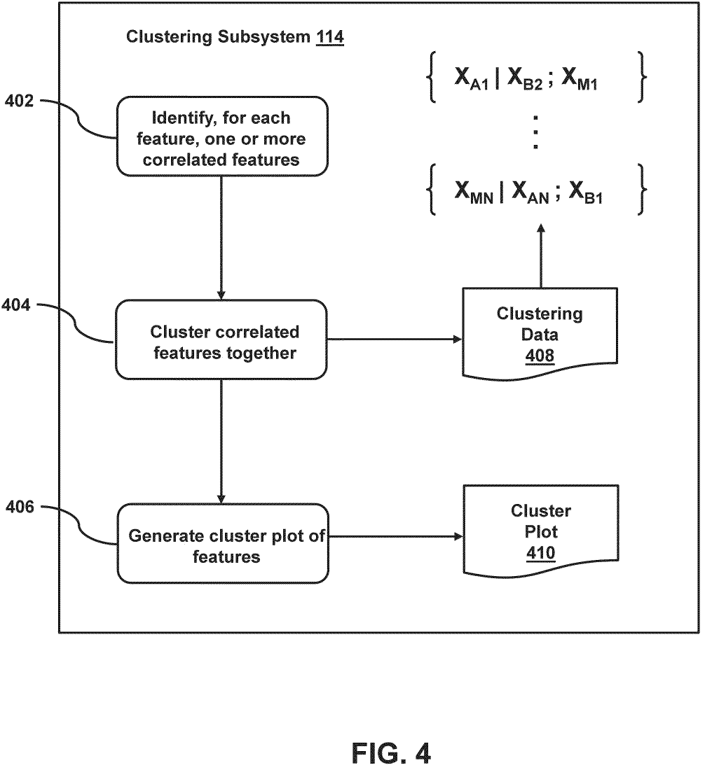

Returning to FIG. 1, clustering subsystem 114 may cluster features together based on the correlation scores. The result of the clustering may be feature clusters each including features that are uncorrelated with one another. As an example, with reference to FIG. 4, clustering subsystem 114 may be configured to identify, for each feature, one or more correlated features at 402. Correlated features may be identified based on correlation scores 310, which indicate whether one feature is correlated to another feature. Identifying correlated features may include identifying how strongly or weakly two features are to one another, but, in particular, identifying whether two features are correlated.

In some embodiments, at 404, correlated features may be clustered together to generate clustering data 408. Clustering data 408 may include each feature extracted from the datasets (e.g., datasets 302) and, for each of the features, any other features determined to be correlated thereto. For example, feature X_{A1} may be determined to be correlated to features X_{B2} and X_{M1}; and feature X_{MN} may be determined to be correlated to features X_{AN} and X_{B1}. In some embodiments, a given feature may be determined to be correlated to two or more other features. In such cases, clustering data 408 may include the given feature may be included in a cluster for each of the two or more other features. In some embodiments, a given feature may be determined to not be correlated with any other features. In such cases, a cluster for the given feature may not include any other features (e.g., {X_{M2} | }).

In some embodiments, clustering data 408 may include the correlation scores associated with each of the feature clusters. For example, the feature cluster for feature X_{A1} may include correlation score S_{A1},_{B2}, which indicates the correlation score for feature X_{A1} and feature X_{B2}. Similarly, the feature cluster for feature X_{A1} may also include correlation score S_{A1,M1}, which indicates the correlation score for feature X_{A1} and feature X_{M1}. In some embodiments, clustering subsystem 114 may further be configured to generate a ranking of the features included within a given feature cluster. The ranking may be determined based on the correlation scores for each feature. Continuing the previous example, features X_{A1} and X_{B2} may be ranked higher than features X_{A1} and feature X_{M1} if correlation score S_{A1},_{B2} is greater than correlation score S_{A1,M1}. In some embodiments, feature clusters may be merged together based on overlapping features. This may reduce the number of feature clusters significantly, leaving only those feature clusters that include features that are correlated with other features in a same feature cluster, and which lack any correlation with features included within any of the other feature clusters.

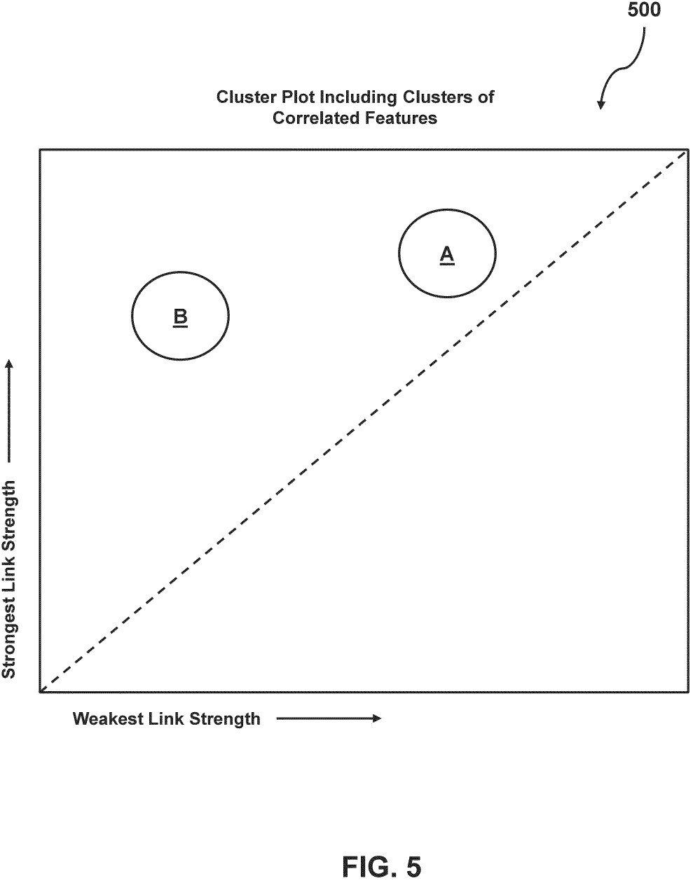

In some embodiments, at 406, a cluster plot 410 may be generated including a visual depiction of the feature clusters identified from clustering data 408. As an example, with reference to FIG. 5, cluster plot 500 includes two feature clusters, feature cluster A and feature cluster B. Each of feature clusters A and B include one or more features. The features included in feature cluster A each have some correlation to one another based on a correlation score for each of those features being non-zero. Similarly, the features included in feature cluster B each have some correlation to one another based on a correlation score for each of those features being non-zero. On the other hand, features included within feature cluster A are determined to have no correlation, or less than a threshold amount of correlation (e.g., correlation score being less than a threshold correlation score), with respect to features included within feature cluster B. For instance, a correlation score S_{A1},_{A2} between two features, feature A₁ and A₂, both included within feature cluster A, may be greater than a threshold correlation score. As an example, S_{A1},_{A2} may be greater than S_{threshold}, where S_{threshold} = 0.2 or less, 0.1 or less, 0.01 or less, 0.001 or less, or other values, or 0. As another example, correlation score S_{1,2} may be non-zero (e.g., S_{A1},_{A2} ≠ 0). However, a correlation score between two features, feature A₁ of feature cluster A and feature B₁ of feature cluster B may be less than a threshold correlation score. As an example, S_{A1},_{B1} may be less than S_{threshold}, As another example, correlation score S_{A1},_{B1} may be zero (e.g., S_{A1},_{B1} = 0).

In some embodiments, a size, shape, color, or other manner of display, of each of feature clusters A and B may be determined based on a number of features included within that feature cluster. For example, the greater the number of features included within a given feature cluster, the greater the size of that feature cluster within the cluster plot.

In some embodiments, each feature cluster included within cluster plot 500 may indicate a strength of the correlation between features of the same feature cluster. For example, in cluster plot 500, the x-axis represents a weakest correlation link strength between pairs of features in a given feature cluster, and the y-axis represents a strongest correlation link strength between pairs of features in the given feature cluster. Therefore, the shape of the feature cluster and the position of the feature cluster within cluster plot 500 may indicate how tightly correlated the features included within a given feature cluster are. As an example, with reference to cluster plot 500, the features included in feature cluster A likely have greater correlation scores than features included in feature cluster B.

Returning to FIG. 1, in some embodiments, model selection subsystem 116 may be configured to determine a machine learning model with which training data is to be generated for. In some embodiments, the machine learning model may be selected based on the input features of the machine learning model. Different machine learning models take, as input, different features. A feature represents a variable that serves as an input to a model and is used by the model to make predictions. In some embodiments, features may be orthogonal to one another. For example, each feature may occupy a dimension of an n-dimensional feature space. Model input parameters, in some cases, may indicate the types of features represented by data used to train a machine learning model, as well as the type of features expected to be represented by data input to trained machine learning model. As an example, data including features, such as noise ratios, lengths of sound, relative power, etc., may serve as an input to a machine learning model related to recognizing phonemes for speech recognition processes. As another example, data including features such as edges, objects, pixel information, may serve as an input to a machine learning model related to computer vision analysis. As still yet another example, data including features, such as income, credit score, and biographical information may serve as an input to a machine learning model related to financial applications. Each of the features (e.g., noise rations, lengths of sound, relative power, edges, objects, income, credit score, biographical information, or other features) may be different types of features. The feature type, which may also be referred to herein interchangeably as “type of feature,” may relate to the genre of the machine learning model (e.g., speech recognition models, computer vision models, etc.) or the different individual fields encompassed by a feature (e.g., length of sounds in units of time, income in units of dollars, etc.). As described herein, a feature type indicates what a particular feature represents. For example, the feature type “salary information” may correspond to the feature “salary,” which may be used as a model input parameter to a financially-related prediction model. In some embodiments, model input parameters may also indicate hyperparameters associated with a trained machine learning model. A hyperparameter represents a configurable variable whose value is estimated by a model based on input data. As an example, for a PCA model, a number of components to keep represents one type of hyperparameter. The training data including a set of features may adjust a value of a configurable variable so as to improve the estimation of the model based on input data (e.g., not training data).

A model’s input parameters may indicate which features are relevant for generating output datasets. The machine learning models may be selected from model database 134 based on a particular process, task, or objective sought to be obtained by the model. For example, a convolutional neural network (CNN) may be selected for processes related to computer vision. The various machine learning models stored by model database 134, include, but are not limited to (which is not to suggest that any other list is limiting), any of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or separable convolutions (e.g., depth-separable convolutions, spatial separable convolutions, etc.).

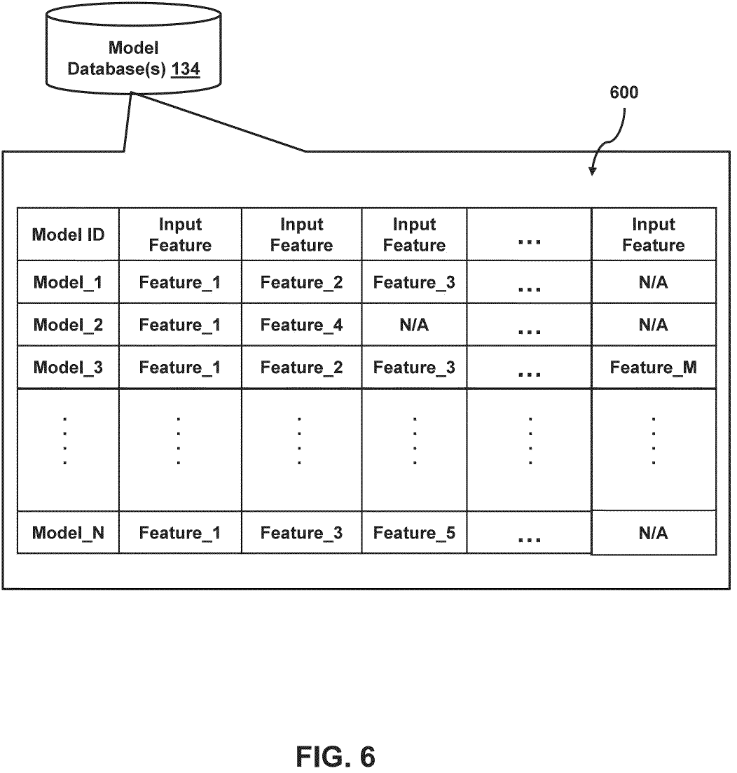

With reference to FIG. 6, table 600 may represent data stored within model database 134 related to each of a plurality of models. Table 600 may be a data structure organized to indicate a model available to be trained to perform a particular task or tasks. Model database 134 may be queried based on a search query including one or more search filters. The search filters may indicate characteristics of the model to be searched for. In some embodiments, table 600 may include a first column including model identifiers (e.g., a string of characters uniquely identifying a particular machine learning model that may be selected for training and/or for which training data may be generated for. For example, table 600 may include N model identifiers, model identifiers Model_1-Model_N. Each model identifier may indicate a particular model, type of model, or both, of a corresponding machine learning model. The particular computer program instructions associated with each machine learning model may be obtained by identifying a repository location of the model within model database 134. To do so, the selected machine learning model identifier may be used as a key for a key-value store stored by model database 134, and a value associated with that key may be retrieved. The value may indicate a database location of the computer program instructions associated with the selected model.

Table 600 may also include an indication of each input feature the given model takes. For example, the machine learning model associated with model identifier “Model_1,” may take, as input, a set of input features including “Feature_1,” “Feature_2,” and “Feature_3.” As another example, the machine learning model associated with model identifier "Model_3," may take, as input, a set of input features include “Feature_1,” “Feature_2,” “Feature_3,” and “Feature_M.” In some embodiments, model selection subsystem 116 may identify the input features associated one or more of the models associated with a corresponding model identifier, and may retrieve the set of input features, or data indicating the set of input features, of the one or more models. For example, model selection subsystem 116 may retrieve the set of input features including “Feature_1,” “Feature_2,” and “Feature_3” in response to a request for determining a machine learning model which for training data is to be generated. In some embodiments, a set of input features associated with each machine learning model (e.g., the machine learning models associated with model identifiers “Model_1” to “Model_M”) may be determined. For example, the input features listed within Table 600 as being inputs for a corresponding machine learning model may be retrieved from model database 134 by model selection subsystem 116.

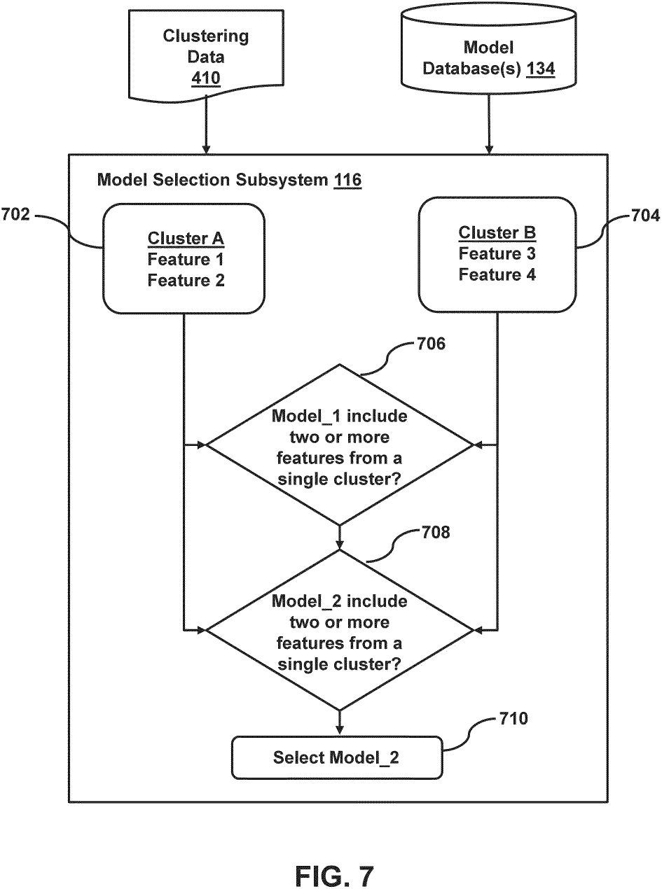

In some embodiments, model selection subsystem 116 may be configured to select a model with which training data is to be generated for based on clustering data 408 and the sets of input features of each machine learning model available for training (e.g., the machine learning models associated with model identifiers Model_1 to Model_N). For example, with reference to FIG. 7, model selection subsystem 116 may identify, based on clustering data 408, the different features included within each feature cluster. For example, model selection subsystem 116 may identify a first group 702 of features included within feature cluster A and a second group 704 of features included within feature cluster B. For instance, first group 702 may indicate that feature cluster A includes "Feature 1" and "Feature 2," and second group 704 may indicate that feature cluster B includes "Feature 3" and "Feature 4." As mentioned previously, because "Feature 1" and "Feature 2" are included in a same feature cluster, "Feature 1" and "Feature 2" may be correlated to one another. Similarly, because “Feature 3” and “Feature 4” are included in a same feature cluster, “Feature 3” and “Feature 4” may be correlated to one another. Furthermore, in some embodiments, because "Feature 1" and "Feature 2" are included in one feature cluster and "Feature 3" and "Feature 4" are included in another feature cluster, "Feature 1" and "Feature 2" are not correlated to "Feature 3" and "Feature 4."

In some embodiments, at 706, model selection subsystem 116 may determine whether a set of input features for a first machine learning model having a model identifier “Model_1” includes two or more features from a same feature cluster. The first machine learning model associated with model identifier “Model_1,” as indicated by Table 600, may have a set of input features including “Feature 1,” “Feature 2,” and “Feature 3.” “Feature 1” and “Feature 2” are both included within a same feature cluster, feature cluster A, therefore selection of the first machine learning model may result in an indication that some of the input features for the first machine learning model are affected by multicollinearity. Therefore, the performance of the first machine learning model may be impacted by “Feature 1” and “Feature 2” having some correlation to one another. As mentioned previously, to provide the most quality to the machine learning model, features should be selected that improve the accuracy of variables predicted by the machine learning model. Using features that are correlated to one another can cause the model’s accuracy and performance to decrease. Therefore, if the first machine learning model is selected, the training data that is generated may be affected by multicollinearity, and thus the quality of the outputs of the first machine learning model may be adversely impacted.

At 708, a determination may be made as to whether a second machine learning model, such as the machine learning model associated with model identifier “Model_2,” includes two or more features from a same cluster. As seen from Table 600, the set of input features for the second machine learning model associated with model identifier “Model_2” may include the features “Feature 1” and “Feature 4.” In some embodiments, “Feature 1” may be included in feature cluster A whereas “Feature 4” may be included in feature cluster B. Therefore, the set of input features for the second machine learning model are each from a separate feature cluster. This indicates that the set of input features for the second machine learning model are not correlated and are free from the effects of multicollinearity. Training data generated to train the second machine learning model that includes “Feature 1” and “Feature 4” can therefore improve the accuracy of the outputs of the second machine learning.

At 710, the second machine learning model may be selected because the set of input features for the second machine learning model (e.g., associated with model identifier “Model_2”) are not correlated with one another. This may allow computer system 102 to generate training data including features “Feature 1” and “Feature 4” such that the training data optimally trains the machine learning model, producing a trained model that has improved accuracy and performance as compared to the same machine learning model if trained with training data include two or more features that are correlated with one another.

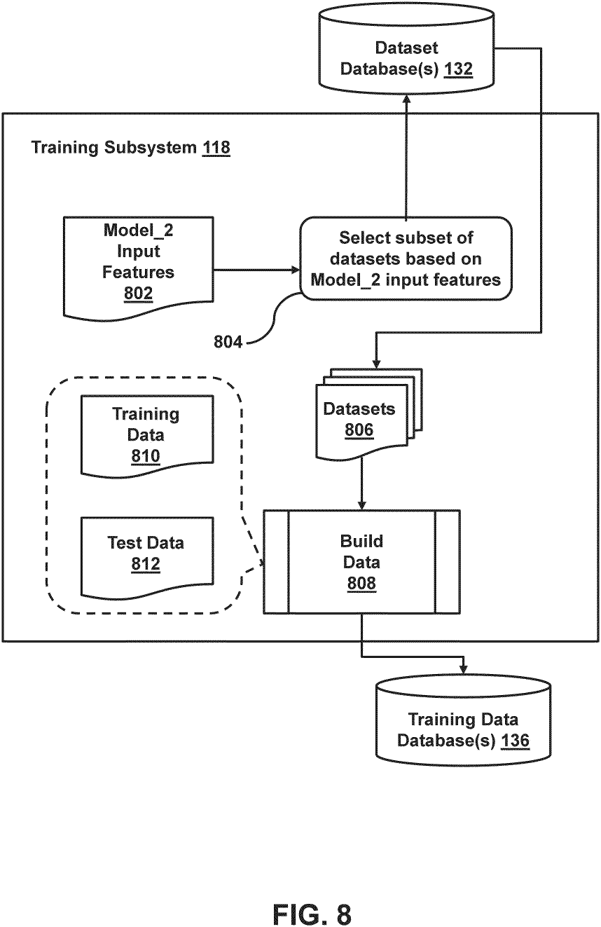

Returning to FIG. 1, training subsystem 118 may be configured to generate training data based on the selected machine learning model, the set of input features associated with the selected machine learning model, the datasets analyzed, or other criteria. In some embodiments, in response to selecting the machine learning model, as described above, training subsystem may be configured to select a subset of datasets based on a set of input features associated with the selected machine learning model. For example, with reference to FIG. 8, training subsystem 118 may obtain input features 802 associated with a machine learning model having a model identifier “Model_2.” As mentioned previously, the machine learning model may be selected based on the set of input features for the machine learning model (e.g., “Feature 1,” “Feature 4”) being included in only one of the feature clusters (e.g., feature cluster A, feature cluster B), and no two feature clusters including two or more features of the set of input features. At 804, a subset of datasets 806 stored in dataset database 132 may be selected based on the set of input features 802 associated with the selected machine learning model. In some embodiments, a subset of datasets may be selected from the datasets retrieved by scoring subsystem 112. For example, datasets 806 may be a subset of datasets 302, described above with reference to FIG. 3. Datasets 806 may include input features 802, and may lack any features that are correlated with one another. In this way, datasets 806 may be free of multicollinearity, which can improve an accuracy of a model to be trained on training data generated from datasets 806.

In some embodiments, training subsystem 118 may be configured to generate build data 808 based on datasets 806. Generating build data 808 may include formatting, transforming, curating, or performing other processes to engineer the features included in datasets 806 for being used to training a machine learning model. For instance, datasets 806 may be organized such that data items included in datasets 806 can be input to a machine learning model, and the hyperparameters of the machine learning model can be adjusted to minimize a cost function of the model. In some embodiments, generating build data 808 may include splitting some of datasets 202 (after being processed for use as inputs to the model) into data to be used to training the model (e.g., training data 810) and data to be used to test an accuracy of the model (e.g., test data 812). In some embodiments, training subsystem 118 may be configured to train a machine learning model based on build data 808 including training data 810 and test data 812. For example, the hyperparameters of the machine learning model may be adjusted based on training data 810, and after the training steps are completed, test data 812 may be used to determine an accuracy of the trained machine learning model. If the accuracy satisfies a threshold accuracy condition (e.g., an accuracy of the model is greater than a threshold accuracy score), then the model may be considered trained and ready for deployment or further testing in order to be deployed. However, if the accuracy does not satisfy the threshold accuracy condition, then new training data may be generated from datasets 806, additional datasets retrieved from dataset database 132 that also include input features 802, or a combination thereof. This process may be repeated until the accuracy of the machine learning model satisfies the threshold accuracy condition, or until another stopping criterion is satisfied.

In some embodiments, one or more quality checks may be performed to datasets 806 prior to generating build data 808. For example, a test may be performed to make sure that none of the datasets include any additional features that may be correlated with input features 802. In some cases, a principal component analysis (PCA) test may be computed based on datasets 806 and input features 802 to determine any correlations of features in datasets 806.

After build data 808 has been generated, it may be provided to training data database 136 for storage. Build data 808 may be retrieved by training subsystem 118 for use when performing the training of the machine learning model. In some embodiments, training subsystem 118 may automatically begin training the machine learning model after build data 808 has been generated.

Returning to FIG. 1, user interface subsystem 120 may be configured to generate one or more user interfaces displaying content, which may be provided to client device 104 for viewing. As an example, user interface subsystem 120 may be configured to generate a user interface including cluster plot 500 of FIG. 5, and the user interface may be provided to client device 104 such that a user of client device may view cluster plot 500. In some embodiments, user interface subsystem 120 may be configured to generate computer readable instructions for rendering a user interface on client device 104, and may provide the computer readable instructions to client device 104 such that, after a cluster plot is generated, the cluster plot may be displayed within the rendered user interface.

In some embodiments, computer system 102 may be further configured to perform additional processes associated with the model development process. For example, quality check 210 can involve performing variable level monitoring for variables to identifies issues in the datasets to be used to generate training data for training the machine learning model. Conventionally this process involves one or more users manually reviewing a large number of plots and using human judgement to identify the potential issues. This process can be very time consuming, and because it relies on human judgement, some issues may slip through undetected. In some embodiments, computer system 102 may be configured to perform additional processes to improve quality check 210 to remove the problems that can arise by having human users review large quantities of plots for possible issues. For example, quality check 210 may perform a process to rank variables based on volatility and trend observed in the data. Quality check 210 may thus benefit from using statistical measures, such as a coefficient of variation (CoV) to guide decisions, and may also rank each variable to identify issues related to those variables.

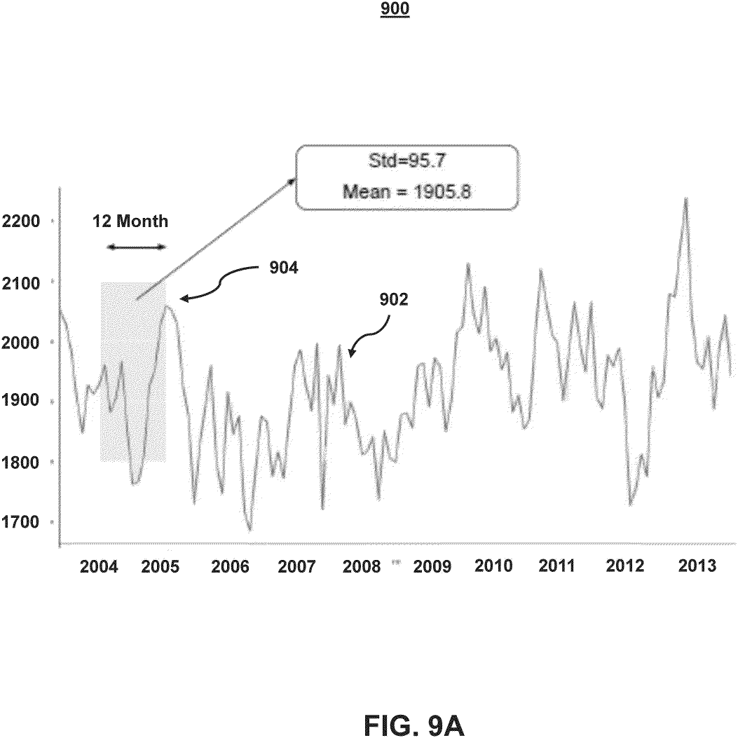

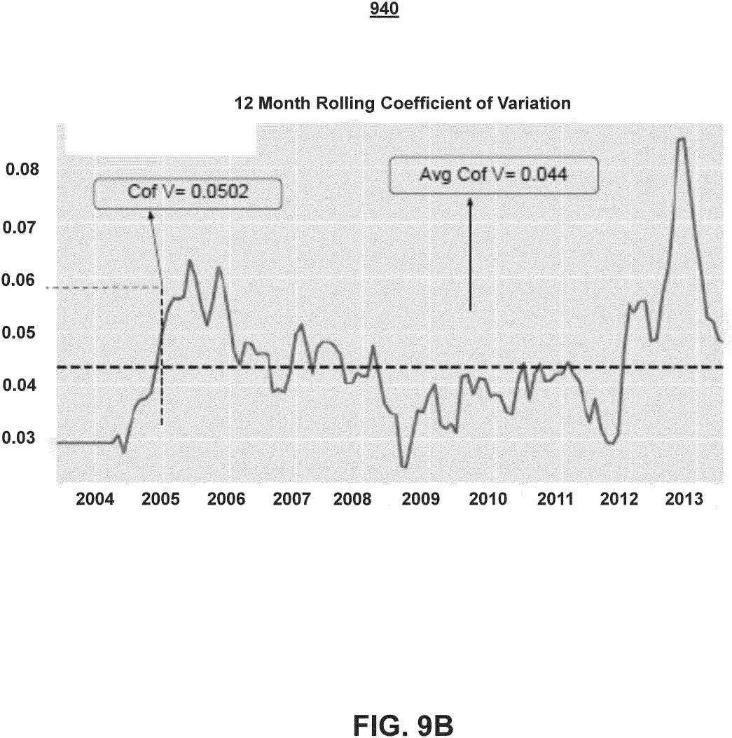

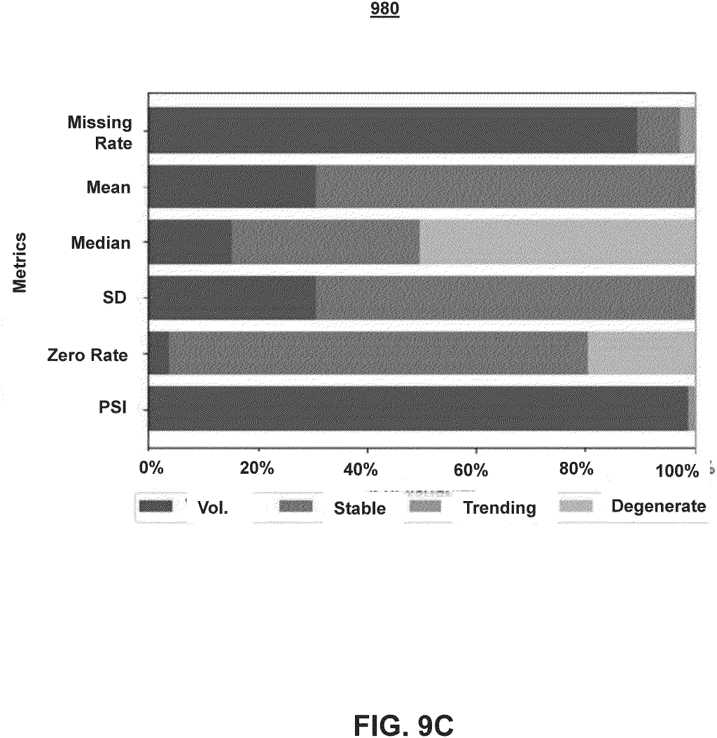

In some embodiments, computer system 102 may be configured to compute a CoV to identify volatility in time series data. As an example, with reference to FIG. 9A, plot 900 may represent time series data 902 over a rolling window of 12 months. The use of 12 months as the rolling window is merely exemplary, and other temporal durations may be used as the rolling window (e.g., 1 month, 3 months, 6 months, 24 months, etc.). For each rolling window, a CoV may be computed for the time series data included in that portion. As an example, window 904 of plot 900 may represent one 12 month window within time series data 902. Within the time period of window 904, the standard deviation of the data may be 95.7 and the mean value of the data may be 1905.8. The units of the data in the example are arbitrary, and may represent a value relevant to the model to be trained. For example, the value may refer to a pixel value for a computer vision model, a credit limit for a financial model, or other values. The CoV is defined as the ratio of the standard deviation to the mean. Therefore, within window 904, the CoV is approximately 0.0502.

For each 12 month temporal window, the corresponding CoV may be computed and plotted in a graph 940 of FIG. 9B, indicated how the CoV varies over time series data 902. An average CoV for the entire time series data 902 may be determined based on the CoV at each point. For example, the average CoV of time series data 902 may be equal to 0.044, which is represented as a dashed line in graph 940.

To determine whether time series data is volatile, a determination may be made as to whether the average CoV for the time series data satisfies a threshold volatility condition. In some embodiments, scoring subsystem 112 may be configured to compute the standard deviation, mean, CoV, and mean CoV for time series data. User interface subsystem 120 may be configured to render user interfaces including plot 900 and graph 940 for display to a user operating client device 104. Additionally, scoring subsystem 112 may be configured to determine whether the mean CoV satisfies the threshold volatility condition. In some embodiments, the threshold volatility condition may be satisfied if the mean CoV is greater than a threshold CoV value. The threshold CoV value may be set by a user prior to analysis and may be adjustable. Some example threshold CoV values include 0.1 or less, 0.2 or less, 0.3 or less, or 0.3 or more. Scoring subsystem 112 may further classify each feature as being volatile or not volatile based on the mean CoV computed for the time series data associated with that feature and the threshold CoV value for that feature. In the example of FIGS. 9A and 9B, for time series data 902, scoring subsystem 112 may determine that the time series data is not volatile if the threshold CoV value is set at 0.2 (e.g., the average CoV = 0.044 which is less than the threshold CoV value = 0.2). In some embodiments, scoring subsystem 112 may be configured to assign a label to each variable included in the input datasets (e.g., datasets 202 of FIG. 2) indicating whether that variable is determined to be volatile or non-volatile.

In some embodiments, an iterative process may be performed to detect the presence of any trends in the time series data. For example, scoring subsystem may fit a trend line or other regression to time series data 902 iteratively after removing extreme observations. In some embodiments, scoring subsystem 112 may be configured to fit a trend line to the time series data using all of the observed data and an equation describing the fitted line may be computed. The slope and R² value for the fitted trend line may then be computed. Features having a value that is furthest from a median value of the time series data may be classified as being an “extreme observation,” and subsequently dropped. After dropping the extreme observation, another trend line may be fit to the data and an equation describing the new fitted line may be computed. If it is determined that a slope of the new fitted line is more significant than the slope of the previous fitted line, then the process may be repeated by identifying and removing a next most extreme observation. In some cases, a slope may be classified as being “more significant” if a p-value of the new fitted line is reduced by 20% or more as compared to the previously fitted line. Other reduction rates and other standards for determining a slope’s significance may also be used (e.g., a reduction in p-value of at least 10%, 15%, 25%, 30%, etc.).

If the slope of the newly fitted trend line is determined to not be more significant than the previously fitted trend line’s slope, then scoring subsystem 112 may be configured to determine whether the R² value is greater than or equal to a threshold value. For example, the threshold value for R² may be 0.5 or more, 0.6 or more, 0.7 or more, 0.8 or more, or other values. If scoring subsystem 112 determines that the slope is significant and the R² value is greater than or equal to the threshold value, then the time series data (e.g., time series data 902) may be classified as being “trending.” However, if the slope is determined to be significant and the R² value is less than the threshold value, then scoring subsystem 112 may determine whether a volatility index for the time series data is “high.” In some embodiments, the volatility of the time series data may be computed based on the standard deviation of the time series data, or other statistical measures of the time series data. In some embodiments, more robust mathematical models may be used to compute the volatility (e.g., Black-Scholes model). Scoring subsystem 112 may use any of the aforementioned techniques to determine whether the volatility index is “high,” and based on this determination, classify the time series data as being “stable” or “volatile.” For example, if the volatility index is greater than a threshold volatility index value, then the time series data may be classified as being volatile. In some embodiments, each variable (e.g., each variable may correspond to its own time series data describing how that variable changes over time) may be ranked for trend by the slope of the corresponding trendline. For example, trend lines having more significant (e.g., steeper) slopes may be ranked higher (or lower) than trend lines having less significant (e.g., shallower) slopes.

In some embodiments, scoring subsystem 112 may provide the volatility information and the trending information to user interface subsystem 120 for generating a chart to be displayed in a user interface representing the behaviors of each variable for various metrics. As an example, with reference to FIG. 9C, chart 980 may be displayed within a user interface, and may include information related to various metrics computed for a variable described by time series data 902. For example, the various metrics may include a missing rate, a mean, a median, a standard deviation, a zero rate, and a population stability index (PSI) metric. Chart 980 provides a user with a compact visual depiction of how the data performs over time, saving the user time when analyzing and reducing a number of extraneous charts needing to be viewed by the user. Therefore, errors can be reduced in identifying problematic variables within datasets 202 by reducing the number of items to be analyzed by the user, and further presenting the user with a simplified and compact chart (e.g., chart 980) describing the various variable level monitoring statistics of each variable.

In some embodiments, computer system 102 may be configured to detect outliers within datasets 202 and drivers of those outliers. An outlier refers to a value or set of values associated with a given feature represented by datasets 202 that deviates from an expected value for that feature. A driver of an outlier refers to a source, reason, influence, or other factor that could cause that particular feature to have an outlier. In some embodiments, computer system 102 may identify outliers using various anomaly detection metrics such as Isolation Forest (IF), Local Outlier Factor (LOF), k-nearest neighbor (KNN), or other techniques, or combinations thereof. The anomaly detection metrics can detect outlier observations in an n-dimensional vector space, where features included in the datasets may be represented using feature vectors of n (or less) dimensionality. Multivariate outliers can be influential observations for a model, and therefore may be more suitable than univariate outliers.

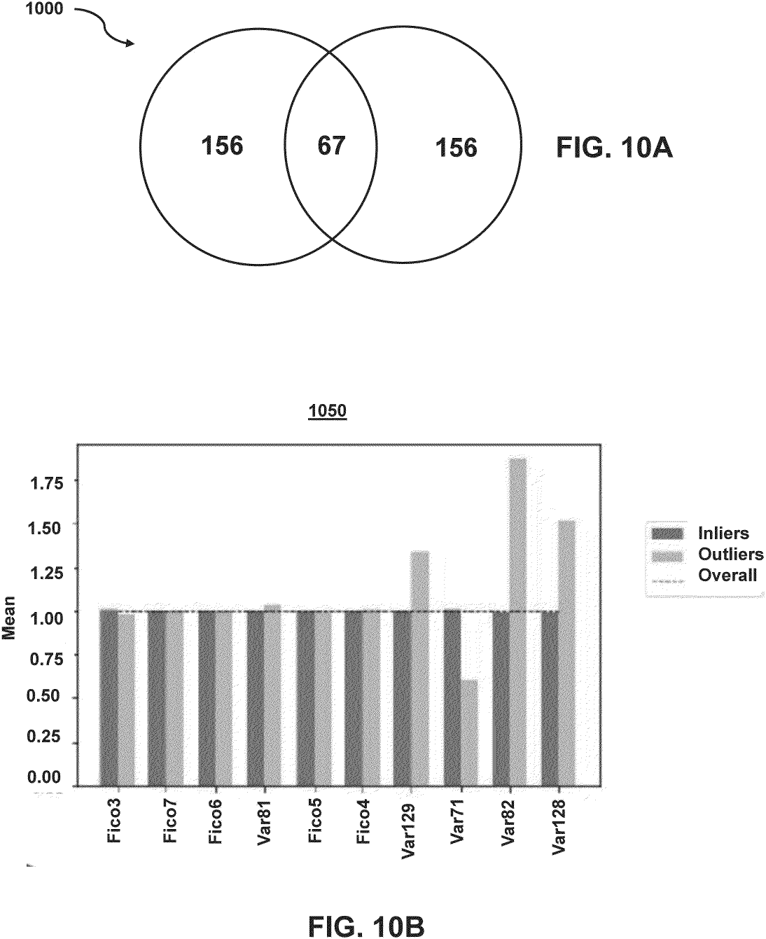

In some embodiments, computer system 102 may be configured to perform a first anomaly detection metric on datasets 202 to identify outliers, as well as a second anomaly detection metric on datasets 202 to identify outliers. As an example, with reference to FIG. 10A, diagram 1000 illustrates two overlapping regions describing outliers detected by the two anomaly detection metrics. A left region of diagram 1000 may represent a number of features classified as being outliers by the first anomaly detection metric, whereas a right region of diagram 1000 may represent a number of features classified as being outliers by the second anomaly detection metric. As an example, the left region may represent features categorized as outliers using the IF metric (e.g., 156 outliers), and the right region may represent features categorized as outliers using the LOF metric (e.g., 156 outliers). In some embodiments, the overlapping region of diagram 1000 may indicate a number of outliers that were identified as being outliers by both the first and second anomaly detection metrics. These outliers can be more influential to the model because more than one anomaly detection metric classified them as being outliers. For instance, because there is a chance that some detected anomalies can be false positives, an observation that is tagged by more than one metric as being an anomaly provides more confidence that the observation is an outlier.

In some embodiments, computer system 102 may use the outlier flags as targets for a GBM model to identify and compare mean values of different potential drivers. As an example, with reference to FIG. 10B, chart 1050 includes different features listed along the x-axis which may be causing an observation of an outlier. Along the y-axis of chart 1050 is a mean value for each of those features. As seen by chart 1050, the feature “Var82” may have a large mean value of outliers, indicating that it may be a potential driver of the outliers detected within the datasets. By identifying the drivers of the outliers, the datasets (e.g., datasets 202) may be cleaned more effectively and efficiently, producing datasets that can be used for model selection and ultimately training data that train models to be more accurate than if those features were not cleaned from the datasets.

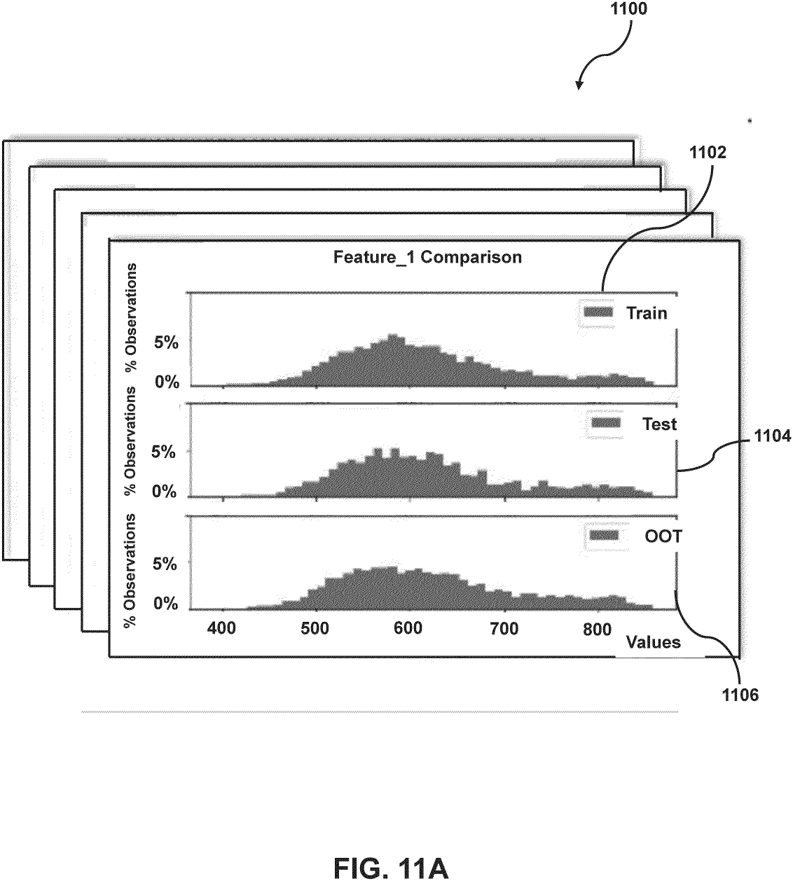

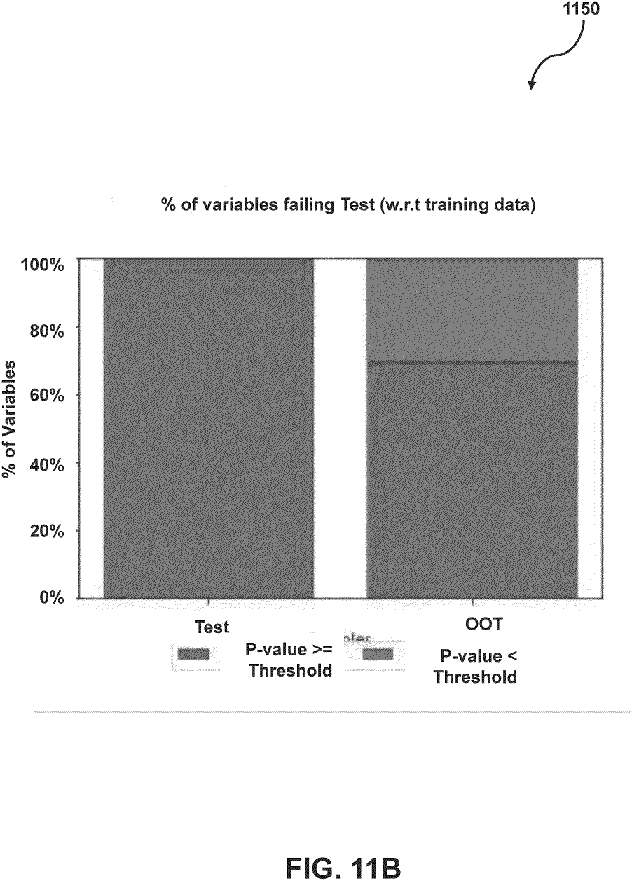

In some embodiments, computer system 102 may further be configured to analyze the test data, the training data, and the OOT data to determine whether these data are distributed consistently. It is expected that the distribution of each feature across the training data, test data, and OOT data are substantially similar. However, if a distribution of the OOT data is vastly different from a distribution of the training data, then this can lead to a model that is unable to handle data inputs and therefore produces poor or inaccurate results. As an example, with reference to FIG. 11A, a set of plots 1100 are displayed. Each plot includes three distributions related to one feature under examination for consistency. For example, plots 1102, 1104, and 1106 may each be associated with a first feature (e.g., feature_1). Plot 1102 may represent a distribution of the first feature within the training data, plot 1104 may represent a distribution of the first feature within the test data, and plot 1106 may represent a distribution of the first feature within the OOT data. If the distributions of plots 1102, 1104, and 1106 differ greatly, then this may indicate that the training data used, or to be used, to train a machine learning model does not accurately reflect the data that is to be fed to the machine learning model during deployment. Therefore, in such scenarios, the training data may be updated, the machine learning model may be re-trained, rebuilt, or both.

In some embodiments, one or more consistency metrics may be performed for each of the different data (e.g., training data, test data, and OOT data), and a determination may be made as to how consistent the data is across the data. For example, a Kolmogorov-Smirnov (KS) test, an Anderson-Darling test, a Population Stability Index (PSI) test, or other tests may be performed on the training data, the test data, and the OOT data. As an example, with reference to FIG. 11B, graph 1150 represents a percentage of variables included in the test data and the OOT data that fail a particular consistency test when compared to the training data. Looking first at the test data, it is seen that substantially all (e.g., approximately 100%) of the test data has a p-value greater than or equal to a threshold p-value when compared to the training data, indicating that the test data and the training data have very similar distributions of the first feature. The OOT data, on the other hand, has approximately 30% of having a p-value that is less than a threshold value. This may indicate that the OOT data does not have a same or similar distribution as compared to the training data, and therefore the training data (and test data) may not accurately depict the type of data that is being, or will be, input to the machine learning model during deployment. In some cases, this may indicate that the training data and test data should be updated to conform to the data the model will encounter during deployment. In some embodiments, the machine learning model may also need to be rebuilt or retrained.

### Example Flowchart

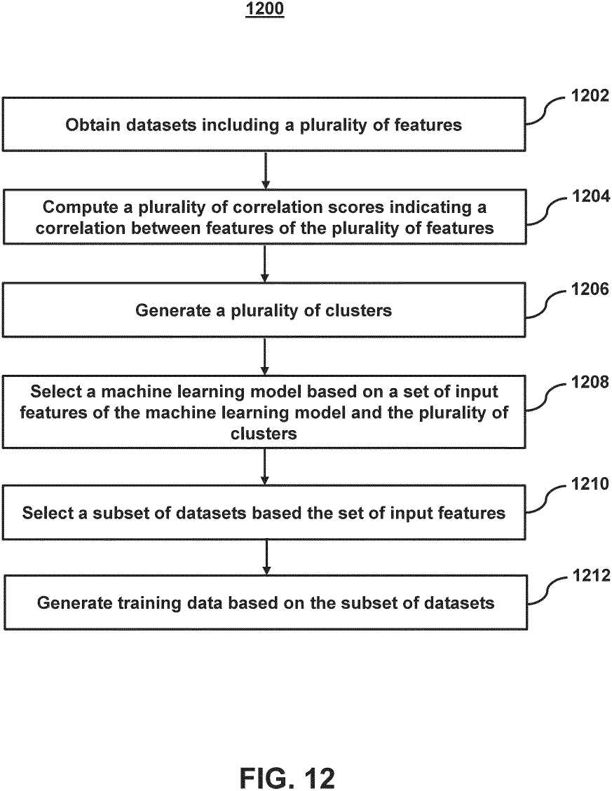

FIG. 12 is an example flowchart of processing operations of a method that enable the various features and functionality of the system as described in detail above. The processing operations of the method presented below are intended to be illustrative and non-limiting. In some embodiments, for example, the method may be accomplished with one or more additional operations not described, and/or without one or more of the operations discussed. Additionally, the order in which the processing operations of the method are illustrated (and described below) is not intended to be limiting.

In some embodiments, the method may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the method in response to instructions stored electronically on an electronic storage medium. The processing devices may include one or more devices configured through hardware, firmware, and/or software to be specifically designed for execution of one or more of the operations of the method.

FIG. 12 shows a flowchart of a method 1200 for generating training data including features having minimized correlation, in accordance with one or more embodiments. In an operation 1202, datasets including a plurality of features may be obtained. The datasets may be obtained from one or more data sources (e.g., dataset database 132). Each dataset may include one or more data items, and the data items may represent various features. As an example, the datasets may include data items representing features such as noise ratios, lengths of sound, relative power, etc. In some embodiments, operation 1202 may be performed by a subsystem that is the same or similar to scoring subsystem 112.

In an operation 1204, a plurality of correlation scores indicating a correlation between features of the plurality of features may be computed. In some embodiments, the features included in the obtained datasets may be extracted, and a correlation score may be computed between each feature and each other feature. The correlation score indicates how strongly correlated two features are. Two features that are correlated may cause similar information to be output by a machine learning model if used as input to the machine learning model. Furthermore, when two features are correlated, adjustments to one of the features may cause the other feature to be adjusted. In some embodiments, operation 1204 may be performed by a subsystem that is the same or similar to scoring subsystem 112.

In an operation 1206, a plurality of feature clusters may be generated. Each cluster may include one or more features that are determined to be correlated with one another. For example, if two features are determined to be correlated, both of those features may be clustered into a same feature cluster. Features that are determined to lack correlation (e.g., correlation score is less than a threshold correlation score, correlation score is zero) may be included in different feature clusters. In some embodiments, operation 1206 may be performed by a subsystem that is the same or similar to clustering subsystem 114.

In an operation 1208, a machine learning model may be selected based on a set of input features of the machine learning model and the plurality of clusters. Each machine learning model (e.g., machine learning models stored in model database 134) may take, as input, a set of input features. For example, with reference to FIG. 6, a first machine learning model may be associated with a first set of input features including “Feature 1,” “Feature 2,” and “Feature 3,” whereas a second machine learning model may be associated with a second set of input features including “Feature 1” and “Feature 4.” In some embodiments, the sets of input features associated with each machine learning model may be determined. In some embodiments, a determination may be made as to whether, for a given set of input features, two or more of the features of the set of input features are included in a same feature cluster. For example, with reference to FIG. 7, feature cluster A includes "Feature 1" and "Feature 2," and feature cluster B includes "Feature 3" and "Feature 4." However, the first set of input features includes "Feature 1," "Feature 2," and "Feature 3," and both "Feature 1" and "Feature 2" are included in feature cluster A. Therefore, if the first machine learning model is selected, at least some of the features used as inputs for the model will be correlated, which can lead to decreased accuracy and performance of the machine learning model. As another example, the second set of input features includes “Feature 1” and “Feature 4,” which are respectively included in feature cluster A and feature cluster B. Therefore, if the second machine learning model is selected, none of the input features for the model will be correlated. In some embodiments, because no input features will be correlated, the second machine learning model may be selected. In some embodiments, operation 1208 may be performed by a subsystem that is the same or similar to model selection subsystem 116.

In an operation 1210, a subset of datasets may be selected based on the set of input features of the selected machine learning model. Using the previous example, if the second machine learning model is selected, datasets including “Feature 1” and “Feature 4” may be selected from dataset database 132. In some embodiments, the selected datasets may only include the features of the selected model’s set of input features. However, in some embodiments, additional features may be included in those datasets. In some cases, additional quality checks may be performed to ensure that the datasets that are selected do not include any correlated features. In some embodiments, the datasets that are selected may be a subset of the obtained datasets from operation 1202. In some embodiments, operation 1210 may be performed by a subset that is the same or similar to training subsystem 118.

In an operation 1212, training data may be generated based on the selected subset of datasets. The training data may be generated such that the training data includes some or all of the subset of datasets. In some embodiments, generating the training data may be part of generating build data. The build data may include the training data and test data, where the test data is used to test an accuracy of the trained machine learning model. The training data, upon generation, may be stored in training data database 136 and used to train the selected machine learning model. In some embodiments, operation 1212 may be performed by a subset that is the same or similar to training subsystem 118.

In some embodiments, the various computers and subsystems illustrated in FIG. 1 may include one or more computing devices that are programmed to perform the functions described herein. The computing devices may include one or more electronic storages (e.g., database(s) 130, which may include dataset database 132, model database 134, training data database 136, etc., or other electronic storages), one or more physical processors programmed with one or more computer program instructions, and/or other components. It should be noted that although the illustrated embodiments include a single instance of dataset database 132, model database 134, and training data database 136, multiple instances of each database may be employed. The computing devices may include communication lines or ports to enable the exchange of information with one or more networks (e.g., network(s) 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-118 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-120 described herein is for illustrative purposes, and is not intended to be limiting, as any of subsystems 112-120 may provide more or less functionality than is described. For example, one or more of subsystems 112-120 may be eliminated, and some or all of its functionality may be provided by other ones of subsystems 112-120. As another example, additional subsystems may be programmed to perform some or all of the functionality attributed herein to one of subsystems 112-120.

Although example embodiments have been described in detail for the purpose of illustration, it is to be understood that such detail is solely for that purpose and that embodiments are not limited to the disclosed embodiments, but, on the contrary, are intended to cover modifications and equivalent arrangements that are within the scope of the appended claims. For example, it is to be understood that embodiments contemplate that, to the extent possible, one or more features of any embodiment can be combined with one or more features of any other embodiment.

As used throughout this application, the word “may” is used in a permissive sense (i.e., meaning having the potential to), rather than the mandatory sense (i.e., meaning must). The words “comprise,” “comprising,” “comprises,” “include”, “including”, and “includes” and the like mean including, but not limited to. As used throughout this application, the singular forms “a,” “an,” and “the” include plural referents unless the context clearly indicates otherwise, and notwithstanding the use of other terms and phrases for one or more elements, such as “one or more.” The term “or” is non-exclusive (i.e., encompassing both “and” and “or”), unless the context clearly indicates otherwise. The term “and/or” is also non-exclusive and is used to refer to both “and” and “or.” Further, unless otherwise indicated, statements that one value or action is “based on” another condition or value encompass both instances in which the condition or value is the sole factor and instances in which the condition or value is one factor among a plurality of factors. Unless the context clearly indicates otherwise, statements that “each” instance of some collection have some property should not be read to exclude cases where some otherwise identical or similar members of a larger collection do not have the property, i.e., each does not necessarily mean each and every.

Additional example embodiments are provided with reference to the following enumerated embodiments:
1. A method comprising: obtaining datasets comprising a plurality of features; computing, based on the datasets, a plurality of correlation scores indicating a correlation between features of the plurality of features; generating, based on the plurality of correlation scores, a plurality of feature clusters, wherein features included in each feature cluster of the plurality of feature clusters lack correlation with features included in other feature clusters of the plurality of feature clusters; selecting a first machine learning model based on a first set of input features associated with the first machine learning model and the plurality of feature clusters; selecting a first subset of the datasets based on the first set of input features; and generating training data for training the first machine learning model based on the first subset of the datasets.
2. The method of embodiment 1, wherein features included in each feature cluster are uncorrelated with features included in each other feature cluster of the plurality of feature clusters.
3. The method of any one of embodiments 1-2, wherein the first machine learning model is selected based on none of the plurality of feature clusters included two or more features included in the first set of input features.
4. The method of any one of embodiments 1-3, further comprising: identifying, prior to the first machine learning model being selected, a plurality of machine learning models from which a machine learning model is to be selected for training; determining a set of input features associated with each machine learning model of the plurality of machine learning models; and determining, based on the set of input features associated with each machine learning model of the plurality of machine learning models, that the first set of input features associated with first machine learning model.
5. The method of any one of embodiments 1-4, wherein the first machine learning model is selected based on a determination that (i) each input feature of the first set of input features is included in only one of the plurality of feature clusters and (ii) each feature cluster of the plurality of feature clusters includes only one input feature of the first set of input features.
6. The method of any one of embodiments 1-5, wherein each dataset of the first subset of datasets comprises one or more features from the first set of input features.
7. The method of any one of embodiments 1-6, wherein the training data comprises the first subset of the datasets having the first set of input features.
8. The method of any one of embodiments 1-7, wherein the features included in each feature cluster of the plurality of feature clusters are determined to lack correlation with the features included in other feature clusters of the plurality of feature clusters based on a corresponding correlation score of the plurality of correlation scores being less than a correlation threshold score.
9. The method of any one of embodiments 1-8, wherein selecting the first subset of the datasets comprises: selecting at least some input features of the first set of input features associated with the first machine learning model, wherein the first subset of the datasets comprise one or more datasets comprises at least some input features of the first set of input features.
10. The method of any one of embodiments 1-9, further comprising: generating a user interface (UI) for displaying the plurality of feature clusters, wherein a size of each feature cluster of the plurality of feature clusters, when displayed via the UI, is associated with a number of features included in the feature cluster.
11. The method of any one of embodiments 1-10, further comprising: determining a second set of input features associated with a second machine learning model; and determining that at least two input features of the second set of input features are included within a same feature cluster of the plurality of feature clusters, wherein the second machine learning model is not selected based on at least two input features of the second set of input features being included in the same feature cluster.
12. The method of any one of embodiments 1-11, wherein clustering comprises: generating an identifier tag for each feature cluster of the plurality of feature clusters; assigned a corresponding identifier tag to each of the features included in each feature cluster of the plurality of feature clusters; and storing the corresponding identifier tag for each of the features included in each feature cluster of the plurality of feature clusters in memory.
13. The method of any one of embodiments 1-12, wherein computing the plurality of correlation scores comprises: generating, using a variance inflation factor (VIF) metric, a correlation value for each feature of the plurality of features with respect to each other feature of the plurality of features, wherein the plurality of correlation scores are computed based on the correlation value for each feature of the plurality of features.
14. The method of any one of embodiments 1-13, wherein the plurality of correlation scores indicate how correlated each feature of the plurality of features is to each other feature of the plurality of features.
15. The method of any one of embodiments 1-14, wherein generating the plurality of feature clusters further comprises ranking features included in each feature cluster of the plurality of feature clusters based on a corresponding correlation score.
16. The method of any one of embodiments 1-15, wherein the plurality of features comprises a first feature and a second feature, a correlation score indicating a correlation of the first feature and the second feature is determined to have a high correlation score indicating that first information described by the first feature is the same or similar to second information described by the second feature, and the first feature and the second feature are clustered into a same feature cluster of the plurality of feature clusters.
17. The method of any one of embodiments 1-16, wherein selecting the first subset of datasets comprises: performing one or more checks to determine whether the first subset of datasets includes any additional features that are correlated with any features of the first set of input features.
18. The method of any one of embodiments 1-17, further comprising: training the first machine learning model using the training data to obtain a trained machine learning model.
19. One or more tangible, non-transitory, machine-readable media storing instructions that, when executed by one or more processors, effectuation operations comprising those of any of embodiments 1-18.
20. A system comprising: one or more processors; and memory storing computer program instructions that, when executed by the one or more processors, cause the one or more processors to effectuate operations comprising those of any of embodiments 1-18.

What is claimed is:

1. A system for minimizing correlation of features in training data specific to a machine learning model to improve information quality of machine learning model outputs, the system comprising:
memory storing computer program instructions; and
one or more processors configured to execute the computer program instructions to effectuate operations comprising:
obtaining, from a database, datasets to be used to generate training data for training a machine learning model, wherein the datasets comprise a plurality of features;
computing, based on the datasets, a plurality of correlation scores each indicating how correlated each feature of the plurality of features is to each other feature of the plurality of features;
clustering the plurality of features into a plurality of feature clusters based on the plurality of correlation scores such that features included in each feature cluster of the plurality of feature clusters lack correlation with features included in all other feature clusters of the plurality of feature clusters;
determining a first set of input features associated with a first machine learning model;
selecting the first machine learning model based on a determination that (i) each input feature of the first set of input features is included in only one of the plurality of feature clusters and (ii) each feature cluster of the plurality of feature clusters includes only one input feature of the first set of input features;
selecting a first subset of the datasets based on the first set of input features such that each dataset of the first subset of the datasets comprises one or more features from the first set of input features; and
generating, based on the first subset of the datasets, first training data for training the first machine learning model such that the first training data comprises the first subset of the datasets having the first set of input features.

2. The system of claim 1, wherein:
a first feature of the plurality of features and a second feature of the plurality of features are determined to lack correlation based on a correlation score computed between the first feature and the second feature being less than a correlation threshold score;
the first feature is clustered into a first feature cluster of the plurality of feature clusters; and
the second feature is clustered into a second feature cluster of the plurality of feature clusters different from the first feature cluster.

3. The system of claim 1, wherein:
a first feature of the plurality of features and a second feature of the plurality of features determined to have a high correlation score indicates that first information described by the first feature is the same or similar to second information described by the second feature; and
the first feature and the second feature are clustered into a same feature cluster of the plurality of feature clusters.

4. The system of claim 1, wherein the operations further comprise:
generating a user interface (UI) for displaying the plurality of feature clusters, wherein a size of each feature cluster of the plurality of feature clusters, when displayed via the UI, is determined based on a number of features included in a corresponding feature cluster of the plurality of feature clusters.

5. A non-transitory computer-readable medium storing computer program instructions that, when executed by one or more processors, effectuate operations comprising:
obtaining datasets comprising a plurality of features;
computing, based on the datasets, a plurality of correlation scores indicating a correlation between features of the plurality of features;
generating, based on the plurality of correlation scores, a plurality of feature clusters, wherein features included in each feature cluster of the plurality of feature clusters lack correlation with features included in other feature clusters of the plurality of feature clusters;
selecting a first machine learning model based on a first set of input features associated with the first machine learning model and the plurality of feature clusters;
selecting a first subset of the datasets based on the first set of input features; and
generating training data for training the first machine learning model based on the first subset of the datasets.

6. The non-transitory computer-readable medium of claim 5, wherein the operations further comprise:
identifying, prior to the first machine learning model being selected, a plurality of machine learning models from which a machine learning model is to be selected for training;
determining a set of input features associated with each machine learning model of the plurality of machine learning models; and
determining, based on the set of input features associated with each machine learning model of the plurality of machine learning models, that the first set of input features associated with first machine learning model.

7. The non-transitory computer-readable medium of claim 5, wherein the first machine learning model is selected based on a determination that (i) each input feature of the first set of input features is included in only one of the plurality of feature clusters and (ii) each feature cluster of the plurality of feature clusters includes only one input feature of the first set of input features.

8. The non-transitory computer-readable medium of claim 5, wherein each dataset of the first subset of datasets comprises one or more features from the first set of input features.

9. The non-transitory computer-readable medium of claim 5, wherein the training data comprises the first subset of the datasets having the first set of input features.

10. The non-transitory computer-readable medium of claim 5, wherein the features included in each feature cluster of the plurality of feature clusters are determined to lack correlation with the features included in other feature clusters of the plurality of feature clusters based on a corresponding correlation score of the plurality of correlation scores being less than a correlation threshold score.

11. The non-transitory computer-readable medium of claim 5, wherein selecting the first subset of the datasets comprises:
selecting at least some input features of the first set of input features associated with the first machine learning model, wherein the first subset of the datasets comprise one or more datasets comprises at least some input features of the first set of input features.

12. The non-transitory computer-readable medium of claim 5, wherein the operations further comprise:
generating a user interface (UI) for displaying the plurality of feature clusters, wherein a size of each feature cluster of the plurality of feature clusters, when displayed via the UI, is associated with a number of features included in the feature cluster.

13. The non-transitory computer-readable medium of claim 5, wherein the operations further comprise:
determining a second set of input features associated with a second machine learning model; and
determining that at least two input features of the second set of input features are included within a same feature cluster of the plurality of feature clusters, wherein the second machine learning model is not selected based on at least two input features of the second set of input features being included in the same feature cluster.

14. The non-transitory computer-readable medium of claim 5, wherein clustering comprises:
generating an identifier tag for each feature cluster of the plurality of feature clusters;
assigned a corresponding identifier tag to each of the features included in each feature cluster of the plurality of feature clusters; and
storing the corresponding identifier tag for each of the features included in each feature cluster of the plurality of feature clusters in memory.

15. The non-transitory computer-readable medium of claim 5, wherein computing the plurality of correlation scores comprises:
generating, using a variance inflation factor (VIF) metric, a correlation value for each feature of the plurality of features with respect to each other feature of the plurality of features, wherein the plurality of correlation scores are computed based on the correlation value for each feature of the plurality of features.

16. A method, implemented by one or more processors configured to execute computer program instructions, wherein the one or more processors, when executing the computer program instructions, cause the method to be performed, the method comprising:
obtaining datasets comprising a plurality of features;
computing, based on the datasets, a plurality of correlation scores indicating a correlation between features of the plurality of features;
generating, based on the plurality of correlation scores, a plurality of feature clusters, wherein features included in each feature cluster of the plurality of feature clusters lack correlation with features included in other feature clusters of the plurality of feature clusters;
selecting a first machine learning model based on a first set of input features associated with the first machine learning model and the plurality of feature clusters;
selecting a first subset of the datasets based on the first set of input features; and
generating training data for training the first machine learning model based on the first subset of the datasets.

17. The method of claim 16, further comprising:
identifying, prior to the first machine learning model being selected, a plurality of machine learning models from which a machine learning model is to be selected for training;
determining a set of input features associated with each machine learning model of the plurality of machine learning models; and
determining, based on the set of input features associated with each machine learning model of the plurality of machine learning models, that the first set of input features associated with first machine learning model.

18. The method of claim 16, further comprising:
selecting at least some input features of the first set of input features associated with the first machine learning model, wherein the first subset of the datasets comprise one or more datasets comprises at least some input features of the first set of input features.

19. The method of claim 16, further comprising:
generating a user interface (UI) for displaying the plurality of feature clusters, wherein a size of each feature cluster of the plurality of feature clusters, when displayed via the UI, is associated with a number of features included in the feature cluster.

20. The method of claim 16, further comprising:
determining a second set of input features associated with a second machine learning model; and
determining that at least two input features of the second set of input features are included within a same feature cluster of the plurality of feature clusters, wherein the second machine learning model is not selected based on the at least two input features of the second set of input features being included in the same feature cluster.
